(19) United States
(12) Patent Application Publication
(10) Pub. No.: US 2009/0206034 A1
(43) Pub. Date: Aug. 20, 2009

(54) MODIFIED SILICA GEL AND USE THEREOF

(76) Inventor: Osakazu Nakajima, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 12/294,554

(22) PCT Filed: Mar. 28, 2007
(86) PCT No.: PCT/JP2007/056590

§ 371 Date: Sep. 25, 2008

(30) Foreign Application Priority Data
Mar. 29, 2006 (JP) 2006-89851

(51) Int. Cl. B01D 15/34; C08G 77/12; C08G 77/04; B01D 15/22

(52) U.S. Cl. 210/635; 528/31; 528/34; 210/198.2

(57) ABSTRACT

A modified silica gel, in which a surface of a silica gel is partially or entirely coated with a polymer or a copolymer of at least one alkyldisilane compound selected from the group consisting of:
compounds represented by General Formula [I]:

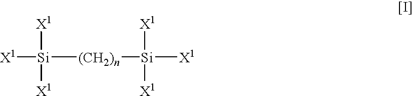

wherein each X¹ is the same or different, and is a hydrogen atom, a halogen atom, or a C₁-C₄ alkoxy group; and n is an integer from 1 to 10; and
compounds represented by General Formula [II]:

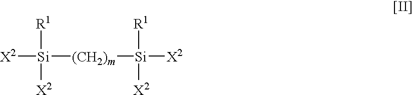

wherein each X² is the same or different, and is a hydrogen atom, a halogen atom, or a C₁-C₄ alkoxy group; each R¹ is the same or different and is a C₁-C₃₀alkyl group; and m is an integer from 1 to 10.

### TECHNICAL FIELD

The present invention relates to silica gels whose surfaces have been modified, a process for producing the silica gels, chromatographic supports using the modified silica gels, liquid chromatographic columns, and a sample analysis or fractionation process.

### BACKGROUND ART

Silica gels, organic polymers, titania, zirconia, alumina, and the like are used as chromatographic supports such as column packings for liquid chromatography. Silica gels, in particular, are often used because they allow solute molecules to easily diffuse into their pores, and exhibit high separation performance.

For example, with regard to supports for partition chromatography, silica gels themselves are used as supports for normal-phase chromatography; and modified silica gels, in which the silanol groups on silica gel surfaces have been chemically modified with alkylsilanes to incorporate therein octadecyl, octyl, butyl, methyl, or like groups, are often used as supports for reverse-phase chromatography.

Acidic or alkaline solutions are often used as mobile phases in analyzing or fractionating compounds by liquid chromatography. When silica gels are used under alkaline conditions, problems occur such as a reduction in the number of theoretical plates or changes in peak shapes, due to the dissolution and the like of the silica gels. Silica gels modified with alkyl groups cannot also avoid deterioration under alkaline conditions.

With regard to a conventional highly durable silica gel for use as a column packing, Patent Document 1 discloses a modified silica gel wherein a portion of the silica gel surface is coated with a silicone polymer with hydrosilyl groups, and wherein the silanol groups have been modified with a first chemically modifying group such as octadecyl groups or the like, and the hydrosilyl groups have been modified with a second chemically modifying group such as sulfone groups or the like.

Patent Document 2 discloses a chromatographic packing composed of porous inorganic/organic hybrid particles, produced by blending compounds containing organic units during the manufacture of silica gel.

The modified silica gel disclosed in Patent Document 1, however, is difficult to mass-produce because surface coating is performed using a hydrosilane, which makes the manufacturing process complicated and the conditions thereof strict. The packing composed of a hybrid material disclosed in Patent Document 2 is not preferable in terms of its properties as a liquid chromatographic packing, and in that it has a separation performance greatly different from that of silica gels.

### Patent Document 1: JP 2003-75421 A

### Patent Document 2: JP 2004-538468 A

### DISCLOSURE OF THE INVENTION

### Problems to Be Solved by the Invention

An object of the invention is to provide modified silica gels with excellent alkali resistance, and chromatographic supports with excellent alkali resistance. Another object of the invention is to provide a simple process for producing modified silica gels with excellent alkali resistance.

### Means for Solving the Problems

The inventors conducted extensive research to solve the above-mentioned these problems, and obtained the following findings.

(i) When a silica gel is reacted with an alkyldisilane compound represented by General Formula [I] and/or General Formula [II] shown below to chemically modify the silanol groups, and then the resulting reaction product is reacted with water to polymerize or copolymerize the alkyldisilane compound on the silica gel surface, a modified silica gel in which the silica gel surface is partially or entirely coated with the polymer or copolymer of the alkyldisilane compound can be obtained.

The resulting modified silica gel exhibits remarkably high alkali resistance.

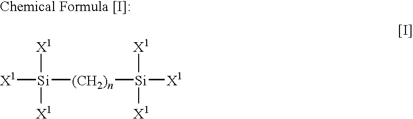

wherein each X¹ is the same or different, and is a hydrogen atom, a halogen atom, or a C₁-C₄ alkoxy group; and n is an integer from 1 to 10.

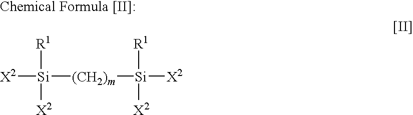

wherein each X² is the same or different, and is a hydrogen atom, a halogen atom, or a C₁-C₄ alkoxy group; each R¹ is the same or different and is a C₁-C₃₀ alkyl group; and m is an integer from 1 to 10.

(ii) When the modified silica gel obtained by the process (i) is reacted with an alkylmonosilane compound represented by General Formula [III] shown below, or is reacted with an alkylmonosilane compound represented by General Formula [III] wherein each

R² is a C₄-C₃₀ alkyl group, and then the resulting reaction product is reacted with an alkylmonosilane compound represented by General Formula [III] wherein each R² is a C₁-C₃ alkyl group, to chemically modify the silanol groups remaining on the surface of the modified silica gel with the alkylmonosilane compound, a two-step modified silica gel can be obtained in which a portion of or all of silanol groups on the surface of the modified silica gel obtained by the process (i) have been modified with the alkylmonosilane compounds shown below.

The resulting two-step modified silica gel exhibits even higher alkali resistance.

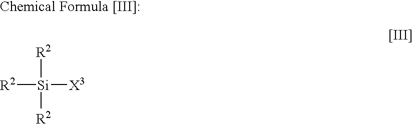

wherein X³ is the same or different, and is a hydrogen atom, a halogen atom, or a C₁-C₄ alkoxy group; and each R² is the same or different and is a C₁-C₃₀ alkyl group.

(iii) When the modified silica gel of the process (i) or the two-step modified silica gel of the process (ii) is used as a chromatographic support, and an alkaline solution is passed through the support, the chromatographic properties of the silica gel do not change.

The invention was accomplished based on these findings, and provides modified silica gels, a process for producing modified silica gels, chromatographic supports, and the like as summarized below.

Item 1. A modified silica gel, in which a surface of a silica gel is partially or entirely coated with a polymer or a copolymer of at least one alkyldisilane compound selected from the group consisting of compounds represented by General Formula [I] above and compounds represented by General Formula [II] above.

Item 2. The modified silica gel according to Item 1, wherein the polymer or copolymer and the silica gel are bonded via a siloxane bond.

Item 3. The modified silica gel according to Item 1 or 2, wherein the weight ratio of the polymer or copolymer relative to the silica gel (the polymer or copolymer/the silica gel) is from 0.01 to 10.

Item 4. The modified silica gel according to any one of Items 1 to 3, wherein the polymer or copolymer coating on the silica gel is from 2 to 20 Å in thickness.

Item 5. A modified silica gel, in which a portion of or all of silanol groups on the surface of the modified silica gel as defined in any one of Items 1 to 4 have been modified with an alkylmonosilane compound represented by General Formula [III] above, or with an alkylmonosilane compound represented by General Formula [III] above wherein each R² is a C₄-C₃₀ alkyl group, and have been further modified with an alkylmonosilane compound represented by General Formula [III] wherein each R² is a C₁-C₃ alkyl group.

Item 6. A modified silica gel obtained by a process including:

a first step of reacting a silica gel with at least one alkyldisilane compound selected from the group consisting of compounds represented by General Formula [I] and compounds represented by General Formula [II] to modify silanol groups of the silica gel with the alkyldisilane compound; and

a second step of reacting the reaction product obtained in the first step with water to polymerize or copolymerize the alkyldisilane compound.

Item 7. The modified silica gel according to Item 6, wherein the weight ratio of the amount of the alkyldisilane compound used in the first step relative to the silica gel (the alkyldisilane compound/the silica gel) is from 0.01 to 10.

Item 8. A modified silica gel obtained by a process including:

a first step of reacting a silica gel with at least one alkyldisilane compound selected from the group consisting of compounds represented by General Formula [I] and compounds represented by General Formula [II] to modify silanol groups of the silica gel with the alkyldisilane compound;

a second step of reacting the reaction product obtained in the first step with water to polymerize or copolymerize the alkyldisilane compound; and

a third step of reacting the reaction product obtained in the second step with an alkylmonosilane compound represented by General Formula [III], or with an alkylmonosilane compound represented by General Formula [III] wherein each R² is a C₄-C₃₀ alkyl group, and then further reacting the resulting reaction product with an alkylmonosilane compound represented by General Formula [III] wherein R² is a C₁-C₃ alkyl group, to modify residual silanol groups with the alkylmonosilane compound.

Item 9. The modified silica gel according to Item 8, wherein the weight ratio of the amount of the alkyldisilane compound used in the first step relative to the silica gel (the alkyldisilane compound/the silica gel) is from 0.01 to 10.

Item 10. A process for producing a modified silica gel including:

a first step of reacting a silica gel with at least one alkyldisilane compound selected from the group consisting of compounds represented by General Formula [I] and compounds represented by General Formula [II] to modify silanol groups of the silica gel with the alkyldisilane compound; and

a second step of reacting the reaction product obtained in the first step with water to polymerize or copolymerize the alkyldisilane compound.

Item 11. The process according to Item 10, wherein the reaction temperature of the first step is from 60 to 200° C., and the reaction temperature of the second step is from 30 to 200° C.

Item 12. The process according to Item 10 or 11, wherein the weight ratio of the amount of the alkyldisilane compound used in the first step relative to the silica gel (the alkyldisilane compound/the silica gel) is from 0.01 to 10.

Item 13. The process according to any one of Items 10 to 12, further including a third step of reacting the reaction product obtained in the second step with an alkylmonosilane compound represented by General Formula [III], or with an alkylmonosilane compound represented by General Formula [III] wherein each R² is a C₄-C₃₀ alkyl group, and then further reacting the resulting reaction product with an alkylmonosilane compound represented by General Formula [III] wherein each R² is a C₁-C₃ alkyl group, to modify residual silanol groups with the alkylmonosilane compound.

Item 14. A chromatographic support containing the modified silica gel as defined in any one of Items 1 to 9.

Item 15. A liquid chromatographic column, which is packed with the chromatographic support as defined in Item 14.

Item 16. A process for analyzing or fractionating a sample, using the chromatographic support as defined in Item 14.

The invention will be described in detail below. The production process will be described first, and subsequently the modified silica gels, chromatographic supports, and the like will be described.

(1) Process for Producing Modified Silica Gel

The process for producing a modified silica gel of the invention includes a first step of reacting a silica gel with at least one alkyldisilane compound selected from the group consisting of compounds represented by General Formula [I] and compounds represented by General Formula [II] to modify the silanol groups of the silica gel with the alkyldisilane compound; and a second step of reacting the reaction product obtained in the first step with water to polymerize or copolymerize the alkyldisilane compound.

Silica Gel

The starting silica gel may typically have a particle diameter of about 1 to about 1,000 μm, and preferably about 2 to about 200 μm. Moreover, the silica gel may be a porous silica gel that typically has a pore diameter of about 10 to about 10,000 Å, and preferably about 50 to about 3,000 Å, and typically has a surface area of about 1 to 1,000 m²/g, and preferably about 5 to about 600 m²/g. Within the above-mentioned range of pore diameters, compounds to be analyzed or fractionated can easily enter through the pores, and a sufficient surface area can be obtained. In addition, within the above-mentioned range of surface areas, the number of silanol groups will be sufficient, and hence the alkali resistance can be sufficiently improved by the surface modification.

While the shape of the silica gel is not limited, it is preferably spherical to obtain high separation performance. The silica gel also preferably has high purity.

Alkyldisilane Compounds of the Invention

In the compounds of General Formula [I], the two silyl groups or substituted silyl groups attached to methylene (—(CH₂)—)ₙ may be the same or different, but are preferably the same in consideration of the ease of manufacture.

Among the compounds of General Formula [I], compounds wherein each X¹ is chlorine or bromine are preferable, and compounds wherein each X¹ is chlorine are more preferable. These compounds are preferable because they are highly reactive with silanol groups.

In addition, among the compounds of General Formula [I], compounds wherein all of the X¹s are methoxy or ethoxy are also preferable, and compounds wherein all of the X¹s are methoxy are more preferable. These compounds are preferable because they do not emit harmful gases during reactions with silanol groups, and the alcohol produced during reactions with silanol groups can be easily removed out of the reaction system by volatilization.

In General Formula [I], n is preferably from 1 to 8, and more preferably from 1 to 3. Within this range, the polymer or copolymer of an alkyldisilane compound of the invention can be easily formed in the planar direction of the silica gel surface. Specific examples of such compounds include bis(dichlorosilyl)methane, bis(trichlorosilyl)methane, bis(trichlorosilyl)ethane, bis(trichlorosilyl)propane, bis(trichlorosilyl)butane, bis(trichlorosilyl)hexane, bis(trichlorosilyl)octane, bis(trimethoxysilyl)ethane, bis(triethoxysilyl)ethane, bis(triethoxysilyl)methane, bis(triethoxysilyl)propane, bis(triethoxysilyl)octane, bis(trimethoxysilyl)octane, and the like. Among these examples, bis(trichlorosilyl)methane, bis(trichlorosilyl)ethane, bis(trichlorosilyl)propane, bis(trimethoxysilyl)ethane, bis(triethoxysilyl)methane, bis(triethoxysilyl)ethane, and bis(triethoxysilyl)propane are preferable; and bis(trichlorosilyl)methane, bis(trichlorosilyl)ethane, and bis(trichlorosilyl)propane are more preferable.

In the compounds of General Formula [II], the two substituted silyl groups attached to methylene (—(CH₂)—)ₙ may be the same or different, but are preferably the same in consideration of the ease of manufacture.

In General Formula [II], R¹ may be a linear, branched, or cyclic alkyl group, but is preferably a linear alkyl group because of its easy availability. Each R¹ preferably has one to three carbon atoms. Within this range, the polymer or copolymer of an alkyldisilane compound of the invention can be easily formed in the planar direction of the silica gel surface.

Moreover, R¹ may be an alkyl group having a terminal aryl, amino (—NH₂), cyano (—CN), or nitro group (—NO₂), and/or at least one non-terminal functional group selected from the group consisting of amide (—NH—C(O)—), carbamate (—O—C(O)—NH—), carbamide (—NH—C(O)—NH—), ester (—O—C(O)—), and carbonate (—O—C(O)—O—) groups.

In the compounds of General Formula [II], compounds wherein each X² is chlorine or bromine are preferable, and compounds wherein each X² is chlorine are more preferable. These compounds are preferable because they are highly reactive with silanol groups.

Among the compounds of General Formula [II], compounds wherein all of the X²s are methoxy are also preferable. These compounds are preferable because they do not emit harmful gases during reactions with silanol groups, and the alcohol produced during reactions with silanol groups can be easily removed from the reaction system by volatilization.

In General Formula [II], m is preferably from 1 to 8, and more preferably 1 to 3. Within this range, the polymer or copolymer of an alkyldisilane compound of the invention can be easily formed in the planar direction of the silica gel surface. Specific examples of such compounds include bis(methyldichlorosilyl)methane, bis(methyldichlorosilyl)ethane, bis(methyldichlorosilyl)propane, bis(methyldichlorosilyl)butane, bis(methyldichlorosilyl)hexane, bis(methyldichlorosilyl)octane, bis(methyldimethoxysilyl)methane, bis(methyldimethoxysilyl)ethane, bis(methyldimethoxysilyl)propane, bis(methyldimethoxysilyl)butane, bis(methyldimethoxysilyl)hexane, bis(methyldimethoxysilyl)octane, and the like. Among these examples, bis(methyldichlorosilyl)methane, bis(methyldichlorosilyl)ethane, bis(methyldichlorosilyl)propane, bis(methyldimethoxysilyl)methane, bis(methyldimethoxysilyl)ethane, and bis(methyldimethoxysilyl)propane are preferable; and bis(methyldichlorosilyl)methane, bis(methyldichlorosilyl)ethane, and bis(methyldichlorosilyl)propane are more preferable.

The compounds of General Formula [I] are preferable to the compounds of General Formula [II] because they have more reactive groups and are easier to polymerize.

Reactions

First Step

First, a silica gel is reacted with at least one alkyldisilane compound selected from the group consisting of compounds represented by General Formula [I] and compounds represented by General Formula [II] to chemically modify silanol groups on the silica gel surface with the alkyldisilane compound. This results in a reaction product in which the alkyldisilane compound is bonded to a portion of or all of the silanol groups of the silica gel via a siloxane bond.

This chemical modification reaction may typically be performed by heating the silica gel together with the alkyldisilane compound as a chemical modifier in a solvent. The reaction temperature is preferably from about 60 to about 200° C., and more preferably from about 100 to about 160° C. Within this range of temperatures, the introduction of the alkyldisilane compound to the silanol groups will proceed sufficiently, and the alkyldisilane compound will not decompose. The reaction time is preferably from about 0.5 to about 20 hours, and more preferably from about 3 to about 10 hours.

While the type of solvent is not limited, suitable examples include aromatic hydrocarbons such as benzene, toluene, xylene, mesitylene, and the like, and substituted aromatic compounds such as dichlorobenzene and the like, which do not react with the alkyldisilane compound and are stable at the reaction temperature.

The weight ratio of the alkyldisilane compound used relative to the silica gel (the alkyldisilane compound/the silica gel) is preferably from about 0.01 to about 10, more preferably from about 0.1 to about 1, and still more preferably from about 0.1 to about 0.5. Within this range of ratios, the alkali resistance can be sufficiently improved without impairing the function of the silica gel as a chromatographic support in the resulting chemically modified silica gel.

The chemical modification reaction is preferably performed in the presence of a basic compound such as pyridine, tributylamine, imidazole, or the like; the presence of such a basic compound promotes the condensation reaction between the silanol groups and the alkyldisilane compound.

<Second Step>

The reaction product after completion of the chemical modification reaction is reacted with water to polymerize the alkyldisilane compound. This polymerization can be performed by mixing the product resulting from the chemical modification reaction in the first step with water, and by heating the mixture as required. In this way, among the functional groups of the alkyldisilane compound, unreacted reactive groups that did not undergo a condensation reaction with silanol groups of the silica gel are hydrolyzed, and are thereby converted to silanol groups.

The temperature of the hydrolysis reaction is preferably from about 30 to about 200° C., and more preferably from about 100 to about 160° C. The time of the hydrolysis reaction is preferably from about 0.5 to about 20 hours, and more preferably from about 1 to about 10 hours. Within these ranges of temperatures and times, the hydrolysis reaction will proceed sufficiently, and the polymerized alkyldisilane compound will not undergo elimination.

The weight ratio of the water used relative to the alkyldisilane compound (the water/the alkyldisilane compound) is preferably from about 0.1 to about 10, and more preferably from about 0.1 to about 2. Within this range, the hydrolysis reaction will proceed sufficiently, and dehydration will not require a long time.

This results in a modified silica gel of the invention in which the silica gel surface is partially or entirely coated with the polymer or copolymer of at least one of the above-mentioned alkyldisilane compounds, and in which the polymer or copolymer is bonded to the silica gel via a siloxane bond formed by condensation.

<Third Step>

In the process of the invention, the thus obtained modified silica gel may be further chemically modified. In this case, the reaction solution after the hydrolysis reaction may be directly used in the subsequent chemical modification reaction, or the solids of the reaction solution may be separated, and washed and dried for use in the subsequent chemical modification reaction.

The second chemical modification reaction is performed by reacting the modified silica gel obtained above with at least one alkylmonosilane compound represented by General Formula [III]. In this way, functional groups derived from the alkylmonosilane compound are introduced to the silanol groups resulting from the above-described hydrolysis of the alkyldisilane compound, as well as to the silanol groups remaining on the silica gel surface.

Each R² is preferably a C₄-C₃₀ alkyl because of its easy availability, and typically, an octadecyl, octyl, or butyl group is used. Representative examples of the compounds of General Formula [III] include octadecyldimethylchlorosilane, octadecyldimethylethoxysilane, octyldimethylchlorosilane, octyldimethylethoxysilane, buthyldimethylchlorosilane, butyldimethylethoxysilane, and the like.

The conditions for the second chemical modification reaction using the alkylmonosilane compound of General Formula [III] are not limited, and the second chemical modification reaction may be performed under known conditions. Typically, the second chemical modification reaction may be performed by heating the modified silica gel and the alkylmonosilane compound in a solvent. The reaction temperature is preferably from about 60 to about 200° C., and more preferably from about 100 to about 160° C. The reaction time is preferably from about 0.5 to about 20 hours, and more preferably from about 3 to about 10 hours.

While the type of solvent is not limited, suitable examples include aromatic hydrocarbons such as benzene, toluene, xylene, mesitylene, and the like, and substituted aromatic compounds such as dichlorobenzene and the like, which do not react with the alkylmonosilane compound and are stable at the reaction temperature.

The weight ratio of the alkylmonosilane compound used relative to the silica gel (the alkylmonosilane compound/the silica gel) is preferably from about 0.01 to about 10, and more preferably from about 0.1 to about 1. The term “silica gel” as used herein refers to the starting silica gel before it is modified with an alkyldisilane compound.

The chemical modification reaction is preferably performed in the presence of a basic compound such as pyridine, tributylamine, imidazole, or the like.

When the alkylmonosilane compound of General Formula [III] contains alkyl groups with four or more carbon atoms and is sterically bulky, some of the silanol groups may remain. In that case, so-called endcapping may be performed as required, by further reacting the reaction product with a second alkylmonosilane compound of the General Formula [III], wherein the alkyl groups have one to three carbon atoms, to modify the unreacted silanol groups with the second alkylmonosilane compound.

Trimethylchlorosilane, trimethylethoxysilane, and the like are typically used as compounds represented by the second alkyl monomer silane compound (compounds of General Formula [III] wherein each R² is a C₁-C₃ alkyl group). Because the second alkylmonosilane reagent is sterically small, it easily reacts with unreacted silanol groups. The reaction conditions are the same as the conditions employed in the chemical modification reaction using the first alkylmonosilane compound of General Formula [III].

This results in a two-step modified silica gel in which a portion of or all of the silanol groups on the surface of the modified silica gel of the invention have been modified with a compound represented by General Formula [III], or with a compound of General Formula [III] wherein each R² is a C₄-C₃₀ alkyl group, and have been further modified with a compound of General Formula [III] wherein each R² is a C₁-C₃ alkyl group.

(2) Modified Silica Gel

The modified silica gel of the invention is a modified silica gel whose surface is partially or entirely coated with a polymer or a copolymer of at least one alkyldisilane compound selected from the group consisting of compounds represented by General Formula [I] and compounds represented by General Formula [II].

More specifically, the modified silica gel of the invention is obtained by a process that includes a first step of reacting a silica gel with at least one alkyldisilane compound selected from the group consisting of compounds represented by General Formula [I] and compounds represented by General Formula [II] to modify the silanol groups of the silica gel with the alkyldisilane compound; and a second step of reacting the reaction product obtained in the first step with water to polymerize or copolymerize the alkyldisilane compound.

In the modified silica gel of the invention, the silica gel is typically bonded to the polymer or copolymer via a siloxane bond formed by condensation.

The weight ratio of the polymer or copolymer relative to the silica gel (the polymer or copolymer/the silica gel) is preferably from about 0.01 to about 10, and more preferably from about 0.1 to about 1. The weight ratio of the polymer or copolymer relative to the silica gel substantially corresponds to the weight ratio of the alkyldisilane compound(s) of General Formula [I] and/or General Formula [II] relative to the silica gel during manufacture.

When the alkyldisilane compound is used within this range of weight ratios, the thickness of the polymer or copolymer coating on the silica gel surface is typically from about 2 to about 30 Å, and particularly from about 2 to about 10 Å. The thickness of the coating of the polymer or copolymer is the value measured according to the BET method, using an automated specific surface area/pore size distribution analyzer.

Moreover, when the alkyldisilane compound is used within this range of weight ratios, a modified silica gel is obtained in which the proportion of elemental carbon is from about 0.5 to about 10%, and particularly from about 1 to about 5%, as measured by elemental analysis. The proportion of elemental carbon in the invention is the value obtained by elemental analysis using combustion analysis.

When the weight ratio and the thickness of the polymer or copolymer are within the above-mentioned ranges, and the proportion of elemental carbon is within the above-mentioned range, the alkali resistance can be sufficiently improved. Moreover, within the above-mentioned ranges, the thickness of the polymer or copolymer layer, as well as the pore size of the silica gel will be suitable, so that the silica gel, when used as a chromatographic support, allows compounds to be analyzed to easily enter through the pores, thereby achieving sufficient separations. In addition, within the above-mentioned ranges, silanol groups present on the interior of the polymer or copolymer layer formed by hydrolysis can also be sufficiently modified with the alkylmonosilane compound, as described below. That is to say, problems associated with steric hindrance do not occur during the modification reaction.

The modified silica gel of the invention may also be a modified silica gel in which a portion of or all of the silanol groups on the surface thereof have been modified with a compound represented by General Formula [III] wherein each R² is a C₁-C₃₀ alkyl, or with a compound of General Formula [III] wherein each R² is a C₄-C₃₀ alkyl, and have been further modified with a compound of General Formula [III] wherein each R² is a C₁-C₃ alkyl.

Such a two-step modified silica gel is obtained by a process that includes, in addition to the first and second steps described above, a third step of reacting the reaction product obtained in the second step with an alkylmonosilane compound represented by General Formula [III], or with an alkylmonosilane compound represented by General Formula [III] wherein each R² is a C₄-C₃₀ alkyl, and then further reacting the resulting reaction product with an alkylmonosilane compound represented by General Formula [III] wherein R² is a C₁-C₃ alkyl, to modify the residual silanol groups with the alkylmonosilane compound.

The weight ratio of the alkylmonosilane compound relative to the silica gel (the alkylmonosilane compound/the silica gel) is preferably from about 0.01 to about 10, and more preferably from about 0.1 to about 1. The weight ratio of the alkylmonosilane compound relative to the silica gel substantially corresponds to the weight ratio of the alkylmonosilane compound(s) of General Formula [III] and/or General Formula [IV] relative to the silica gel during manufacture.

When the alkylmonosilane compound is used within this range of weight ratios, a two-step modified silica gel is obtained in which the proportion of elemental carbon is typically from about 5 to about 30%, and particularly from about 10 to about 25%, as measured by elemental analysis.

When the weight ratio of the alkylmonosilane compound and the proportion of elemental carbon are within the above-mentioned ranges, the alkali resistance can be sufficiently improved.

(3) Chromatographic Support, Liquid Chromatographic Column, and Analytic or Fractionation Process

The chromatographic support of the invention contains the above-described modified silica gel of the invention. The types of chromatography are not limited. Various types of chromatography such as column chromatography, thin-layer chromatography, and the like may be used. Partition chromatography, adsorption chromatography, gel permeation chromatography, ion exchange chromatography, and the like may also be used.

In a modified silica gel obtained by modifying the silanol groups of a silica gel with an alkyldisilane compound, and then adding water to polymerize or copolymerize the alkyldisilane compound, silanol groups are produced on the surface by hydrolysis. Such a first-step modified silica gel can be suitably used as a support for normal-phase partition chromatography, for example. The first-step modified silica gel exhibits alkali resistance superior to that of the starting silica gel, because it is coated with a polymer containing a carbon chain.

The second-step modified silica gel, in which the residual silanol groups of the first-step modified silica gel have been modified with an alkylmonosilane compound, is highly hydrophobic, and thus can be suitably used as a support for reverse-phase partition chromatography, for example.

The liquid chromatographic column of the invention is a column packed with the modified silica gel of the invention.

The process for analyzing or fractionating a sample of the invention is a process for analyzing (qualitatively or quantitatively), or fractionating or preparatively isolating a sample by any type of chromatography using the chromatographic support of the invention.

The modified silica gel of the invention, when used as a chromatographic support, does not show a deterioration in separation performance and the like even if an alkaline solution is passed therethrough, and has an extended lifetime.

### EFFECTS OF THE INVENTION

The modified silica gels of the invention exhibit excellent resistance to alkaline solutions while maintaining the excellent separation performance of such silica gels as chromatographic supports. Therefore, the modified silica gels retain their separation performance for a long period of time even after use under alkaline conditions.

The process of the invention enables the production of modified silica gels with excellent alkali resistance through easy steps, using a simple reaction installation, and at low cost.

### BRIEF DESCRIPTION OF THE DRAWINGS

FIG. 1 is a graph showing changes observed from the initial state of the elution times of naphthalene peaks measured in column standard tests performed after 2, 4, 7, and 11 hours of passing an alkaline mobile phase through each of the columns packed with the liquid chromatographic packing obtained in each of Examples 1 to 6 and Comparative Examples 1 and 2.

FIG. 2 (A) is a liquid chromatogram of a column standard test performed on the liquid chromatographic packing obtained in Example 1 before passing an alkaline solution; and FIG. 2 (B) is a liquid chromatogram of a column standard test performed on the liquid chromatographic packing obtained in Example 1 after an alkaline solution had been passed through the column for 11 hours.

FIG. 3 (A) is a liquid chromatogram of a column standard test performed on the liquid chromatographic packing obtained in Comparative Example 1 before passing an alkaline solution; and FIG. 3 (B) is a liquid chromatogram of a column standard test performed on the liquid chromatographic packing obtained in Comparative Example 1 after an alkaline solution had been passed through the column for 11 hours.

FIG. 4 is a graph showing the relationship between the amount of alkyldisilane compound used and the pore diameter distribution of the silica gel.

### BEST MODE FOR CARRYING OUT THE INVENTION

The invention will be described in greater detail below with reference to Examples, but the invention is not limited by these Examples.

In the following Examples, elemental analysis was performed by combustion analysis, using an organic elemental analyzer (CHN Coder MT-6M, from YANACO Analytical Instruments Corporation), and the proportion of elemental carbon was determined. In addition, using an automated gas adsorption measuring apparatus (AUTOSORB-1-KR, from Quantachrome Instruments) as an automated specific surface area/pore size distribution analyzer, the pore diameter of the silica gel and the pore diameter of the modified silica gel were measured according to the BET method (multipoint), and half of the difference between these pore diameters was determined as the thickness of the polymer coating.

### EXAMPLE 1

Using a 300 ml three-necked flask, 30 g of Daisogel SP-120-5P (a highly pure spherical silica gel, average particle diameter: 5 μm; pore size: 120 Å; surface area: 300 m²/g) was subjected to azeotropic dehydration in 150 ml of toluene in a nitrogen atmosphere, and subsequently 5.5 g of bis(trichlorosilyl)methane and 9.4 g of pyridine were added thereto, and the mixture was refluxed while heating for 4 hours. After cooling to room temperature, 2.0 g of pure water was added to the resulting product, and the mixture was refluxed for 2 hours until the hydrolysis reaction was completed. After cooling to room temperature, the reaction product was again subjected to azeotropic dehydration, and then 14.1 g of octadecyldimethylchlorosilane and 3.5 g of pyridine were added thereto, and the mixture was refluxed while heating for 4 hours. After cooling to room temperature, 3.9 g of trimethylchlorosilane and 2.9 g of pyridine were added to the resulting product for endcapping, and the mixture was refluxed for 4 hours until the reaction was completed. After completion of the reaction, the reaction product was cooled to room temperature, and then filtered and washed in 200 ml of methanol ten times. The resulting product was then dried under reduced pressure at 70° C. for 24 hours to yield a liquid chromatographic packing.

### EXAMPLE 2

The procedure of Example 1 was repeated, except that bis(trichlorosilyl)ethane was used as an alkyldisilane compound instead of bis(trichlorosilyl)methane.

More specifically, using a 300 ml three-necked flask, 30 g of Daisogel SP-120-5P (a highly pure spherical silica gel, average particle diameter: 5 μm; pore size: 120 Å; surface area: 300 m²/g) was subjected to azeotropic dehydration in 150 ml of toluene in a nitrogen atmosphere, and subsequently 5.8 g of bis(trichlorosilyl)ethane and 9.4 g of pyridine were added thereto, and the mixture was refluxed while heating for 4 hours. After cooling to room temperature, 2.0 g of pure water was added to the resulting product, and the mixture was refluxed for 2 hours until the hydrolysis reaction was completed. After cooling to room temperature, the reaction product was again subjected to azeotropic dehydration, and then 14.1 g of octadecyldimethylchlorosilane and 3.5 g of pyridine were added thereto, and the mixture was refluxed while heating for 4 hours. After cooling to room temperature, 3.9 g of trimethylchlorosilane and 2.9 g of pyridine were added to the resulting product for endcapping, and the mixture was refluxed for 4 hours until the reaction was completed. After completion of the reaction, the reaction product was cooled to room temperature, and then filtered and washed in 200 ml of methanol ten times. The resulting product was then dried under reduced pressure at 70° C. for 24 hours to yield a liquid chromatographic packing.

### EXAMPLE 3

The procedure of Example 1 was repeated, except that bis(trichlorosilyl)propane was used as an alkyldisilane compound instead of bis(trichlorosilyl)methane.

More specifically, using a 300 ml three-necked flask, 30 g of Daisogel SP-120-5P (a highly pure spherical silica gel, average particle diameter: 5 μm; pore size: 120 Å; surface area: 300 m²/g) was subjected to azeotropic dehydration in 150 ml of toluene in a nitrogen atmosphere, and subsequently 6.1 g of bis(trichlorosilyl)propane and 9.4 g of pyridine were added thereto, and the mixture was refluxed while heating for 4 hours. After cooling to room temperature, 2.0 g of pure water was added to the resulting product, and the mixture was refluxed for 2 hours until the hydrolysis reaction was completed. After cooling to room temperature, the reaction product was again subjected to azeotropic dehydration, and then 14.1 g of octadecyldimethylchlorosilane and 3.5 g of pyridine were added thereto, and the mixture was refluxed while heating for 4 hours. After cooling to room temperature, 3.9 g of trimethylchlorosilane and 2.9 g of pyridine were added to the resulting product for endcapping, and the mixture was refluxed for 4 hours until the reaction was completed. After completion of the reaction, the reaction product was cooled to room temperature, and then filtered and washed in 200 ml of methanol ten times. The resulting product was then dried under reduced pressure at 70° C. for 24 hours to yield a liquid chromatographic packing.

### EXAMPLE 4

The procedure of Example 1 was repeated, except that bis(trichlorosilyl)hexane was used as an alkyldisilane compound instead of bis(trichlorosilyl)methane.

More specifically, using a 300 ml three-necked flask, 30 g of Daisogel SP-120-5P (a highly pure spherical silica gel, average particle diameter: 5 μm; pore size: 120 Å; surface area: 300 m²/g) was subjected to azeotropic dehydration in 150 ml of toluene in a nitrogen atmosphere, and subsequently 6.9 g of bis(trichlorosilyl)hexane and 9.4 g of pyridine were added thereto, and the mixture was refluxed while heating for 4 hours. After cooling to room temperature, 2.0 g of pure water was added to the resulting product, and the mixture was refluxed for 2 hours until the hydrolysis reaction was completed. After cooling to room temperature, the reaction product was again subjected to azeotropic dehydration, and then 14.1 g of octadecyldimethylchlorosilane and 3.5 g of pyridine were added thereto, and the mixture was refluxed while heating for 4 hours. After cooling to room temperature, 3.9 g of trimethylchlorosilane and 2.9 g of pyridine were added to the resulting product for endcapping, and the mixture was refluxed for 4 hours until the reaction was completed. After completion of the reaction, the reaction product was cooled to room temperature, and then filtered and washed in 200 ml of methanol ten times. The resulting product was then dried under reduced pressure at 70° C. for 24 hours to yield a liquid chromatographic packing.

### EXAMPLE 5

The procedure of Example 1 was repeated, except that bis(trichlorosilyl)octane was used as an alkyldisilane compound instead of bis(trichlorosilyl)methane.

More specifically, using a 300 ml three-necked flask, 30 g of Daisogel SP-120-5P (a highly pure spherical silica gel, average particle diameter: 5 μm; pore size: 120 Å; surface area: 300 m²/g) was subjected to azeotropic dehydration in 150 ml of toluene in a nitrogen atmosphere, and subsequently 7.4 g of bis(trichlorosilyl)octane and 9.4 g of pyridine were added thereto, and the mixture was refluxed while heating for 4 hours. After cooling to room temperature, 2.0 g of pure water was added to the resulting product, and the mixture was refluxed for 2 hours until the hydrolysis reaction was completed. After cooling to room temperature, the reaction product was again subjected to azeotropic dehydration, and then 14.1 g of octadecyldimethylchlorosilane and 3.5 g of pyridine were added thereto, and the mixture was refluxed while heating for 4 hours. After cooling to room temperature, 3.9 g of trimethylchlorosilane and 2.9 g of pyridine were added to the resulting product for endcapping, and the mixture was refluxed for 4 hours until the reaction was completed. After completion of the reaction, the reaction product was cooled to room temperature, and then filtered and washed in 200 ml of methanol ten times. The resulting product was then dried under reduced pressure at 70° C. for 24 hours to yield a liquid chromatographic packing.

### EXAMPLE 6

The procedure of Example 1 was repeated, except that bis(methyldichlorosilyl)ethane was used as an alkyldisilane compound instead of bis(trichlorosilyl)methane.

More specifically, using a 300 ml three-necked flask, 30 g of Daisogel SP-120-5P (a highly pure spherical silica gel, average particle diameter: 5 μm; pore size: 120 Å; surface area: 300 m²/g) was subjected to azeotropic dehydration in 150 ml of toluene in a nitrogen atmosphere, and subsequently 5.0 g of bis(methyldichlorosilyl)ethane and 5.5 g of pyridine were added thereto, and the mixture was refluxed while heating for 4 hours. After cooling to room temperature, 2.0 g of pure water was added to the resulting product, and the mixture was refluxed for 2 hours until the hydrolysis reaction was completed. After cooling to room temperature, the reaction product was again subjected to azeotropic dehydration, and then 14.1 g of octadecyldimethylchlorosilane and 3.5 g of pyridine were added thereto, and the mixture was refluxed while heating for 4 hours. After cooling to room temperature, 3.9 g of trimethylchlorosilane and 2.9 g of pyridine were added to the resulting product for endcapping, and the mixture was refluxed for 4 hours until the reaction was completed. After completion of the reaction, the reaction product was cooled to room temperature, and then filtered and washed in 200 ml of methanol ten times.

The resulting product was then dried under reduced pressure at 70° C. for 24 hours to yield a liquid chromatographic packing.

### Comparative Example 1

As a comparative example, a conventional modified silica gel was prepared by directly introducing octadecyl and methyl groups to a silica gel, without using an alkyldisilane compound of General Formula [I] or [II].

More specifically, using a 300 ml three-necked flask, 30 g of Daisogel SP-120-5P (a highly pure spherical silica gel, average particle diameter: 5 μm; pore size: 120 Å; surface area: 300 m²/g) was subjected to azeotropic dehydration in 150 ml of toluene in a nitrogen atmosphere, and subsequently 14.1 g of octadecyldimethylchlorosilane and 3.5 g of pyridine were added thereto, and the mixture was refluxed while heating for 4 hours. After cooling to room temperature, 3.9 g of trimethylchlorosilane and 2.9 g of pyridine were added to the resulting product for endcapping, and the mixture was refluxed for 4 hours until the reaction was completed. After completion of the reaction, the reaction product was cooled to room temperature, and then filtered and washed in 200 ml of methanol ten times. The resulting product was then dried under reduced pressure at 70° C. for 24 hours to yield a liquid chromatographic packing.

### Comparative Example 2

As a comparative example, a two-step modified silica gel was prepared using methyltrichlorosilane instead of an alkyldisilane compound of General Formula [I] or [II].

More specifically, using a 300 ml three-necked flask, 30 g of Daisogel SP-120-5P (a highly pure spherical silica gel, average particle diameter: 5 μm; pore size: 120 Å; surface area: 300 m²/g) was subjected to azeotropic dehydration in 150 ml of toluene in a nitrogen atmosphere, and subsequently 2.9 g of methyltrichlorosilane and 4.7 g of pyridine were added thereto, and the mixture was refluxed while heating for 4 hours. After cooling to room temperature, 2.0 g of pure water was added to the resulting product, and the mixture was refluxed for 2 hours until the hydrolysis reaction was completed. After cooling to room temperature, the reaction product was again subjected to azeotropic dehydration, and then 14.1 g of octadecyldimethylchlorosilane and 3.5 g of pyridine were added thereto, and the mixture was refluxed while heating for 4 hours. After cooling to room temperature, 3.9 g of trimethylchlorosilane and 2.9 g of pyridine were added to the resulting product for endcapping, and the mixture was refluxed for 4 hours until the reaction was completed. After completion of the reaction, the reaction product was cooled to room temperature, and then filtered and washed in 200 ml of methanol ten times.

The resulting product was then dried under reduced pressure at 70° C. for 24 hours to yield a liquid chromatographic packing.

Alkali Resistance Test

A stainless-steel column with an inside diameter of 4.6 mm and a length of 150 mm was packed with each of the liquid chromatographic packings obtained in Examples 1 to 6 and Comparative Examples 1 and 2, using the slurry method.

An alkaline mobile phase was passed through each column, and then stopped after 2, 4, 7, and 11 hours. Column standard tests were performed using these columns. More specifically, a standard sample was applied to these columns, and chromatograms were obtained, from which the elution times of naphthalene peaks were measured. Conditions for the column standard tests were as follows.

<Conditions for Passing the Alkaline Mobile Phase>
Mobile phase: acetonitrile/0.01 N sodium hydroxide solution (pH=12)=10/90 (volume ratio)
Flow rate: 1.0 ml/min
Temperature: 40° C.

<Conditions for Column Standard Tests>
Mobile phase: methanol/water=60/40 (volume ratio)
Flow rate: 1.0 ml/min
Temperature: 40° C.
Detected UV wavelength: 254 nm
Quantity of sample: 1.0 μl
Sample: (1) uracil (2) methyl benzoate (3) toluene (4) naphthalene

<Calculation of the Retention of the Elution Times of Naphthalene Peaks>

Retention (%)=[(the elution time for naphthalene after passing the alkaline solution)/(the elution time for naphthalene before passing the alkaline solution)]×100

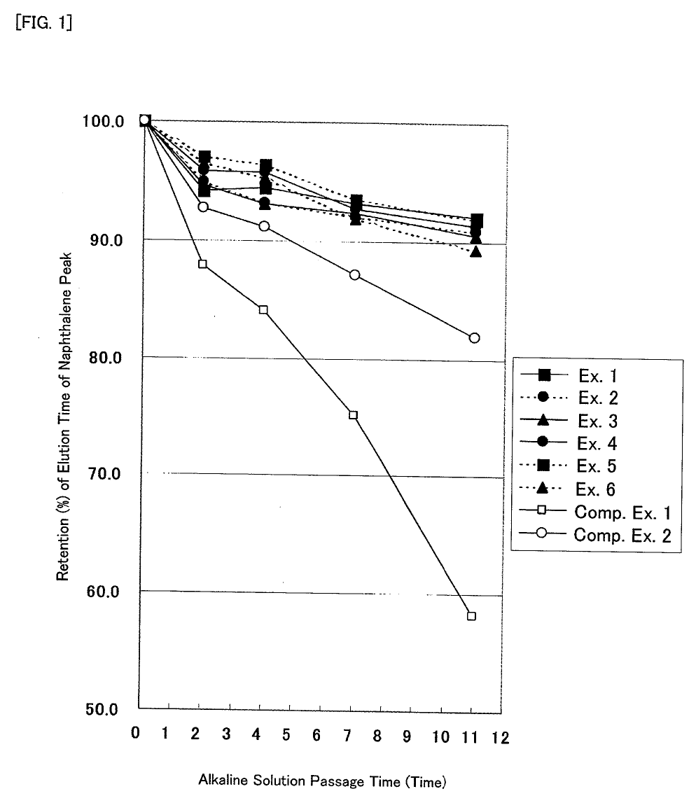

FIG. 1 shows changes in the elution times of naphthalene peaks observed from the initial state. As can be seen from FIG. 1, the elution times of the peaks gradually became more rapid as the alkaline solution was passed through the columns. This is considered to be due to the dissolution of the silica gel itself.

With each of the packings of Examples 1 to 6, which was obtained by chemically modifying the silica gel surface using an alkyldisilane compound represented by General Formula [I] or [II], and then introducing octadecyl groups to the modified product, there was only a small change in the elution time of the naphthalene peak even after the passage of alkaline solution, and the peak time retention was high. That is to say, these packings exhibited high alkali resistance.

Conversely, with the packing of Comparative Example 1, which was obtained by chemically modifying the silica gel by directly introducing octadecyl groups to the silica gel, there was a significant change in the elution time of the naphthalene peak after the passage of the alkaline solution, and the peak time retention was low. That is to say, the packing had poor alkali resistance. It can also be seen that the packing of Comparative Example 2, which was obtained by surface modifying the silica gel with methyltrichlorosilane having a simple structure instead of an alkyldisilane compound represented by General Formula [I] or [II], did not produce a sufficient effect.

These results reveal that alkali resistance can be substantially improved by chemically modifying the surface of a silica gel with an alkyldisilane compound with a hydrocarbon chain in its structure such as an alkyldisilane compound of General Formula [I] or [II].

Chromatograms Measured Before and After the Passage of the Alkaline Mobile Phase

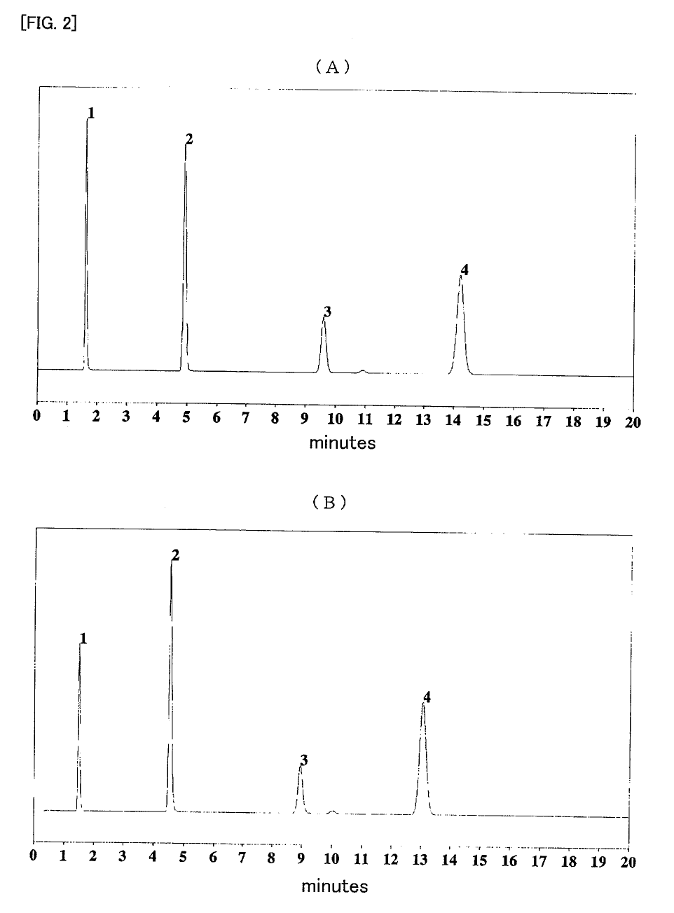

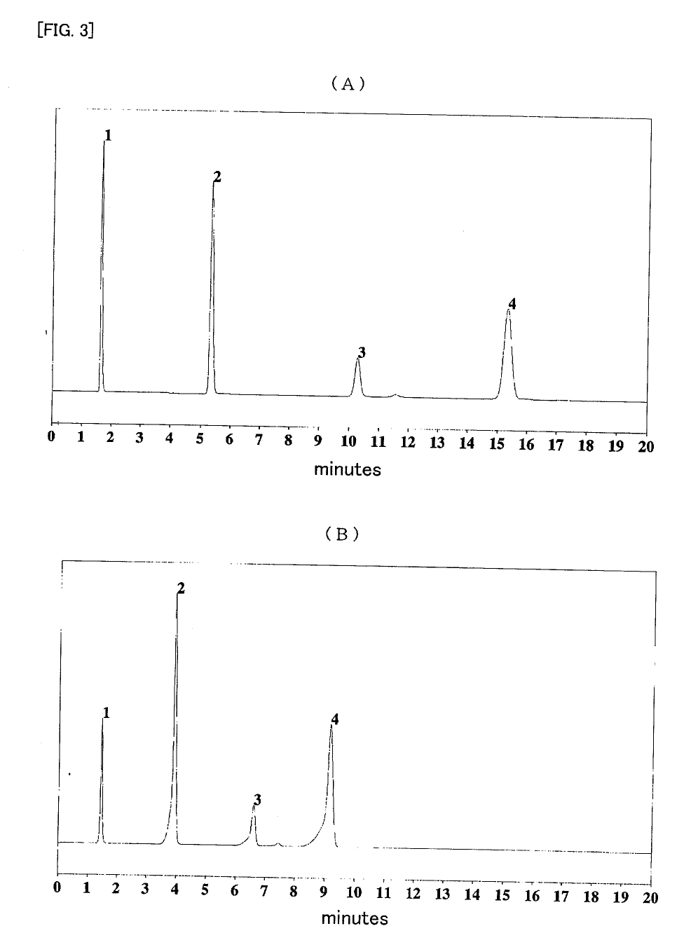

FIG. 2 and FIG. 3 show the chromatograms of each of the liquid chromatographic packings obtained in Example 1 and Comparative Example 1, respectively, measured in column standard tests performed before and after the alkaline mobile phase had been passed through the packings for 11 hours, as described above. FIG. 2 (A) shows a chromatogram measured before the alkaline mobile phase was passed through the packing of Example 1, and FIG. 2 (B) shows a chromatogram measured after the alkaline mobile phase had been passed through the packing of Example 1. FIG. 3 (A) shows a chromatogram measured before the alkaline mobile phase was passed through the packing of Comparative Example 1, and FIG. 3 (B) shows a chromatogram measured after the alkaline mobile phase had been passed through the packing of Comparative Example 1.

As shown in FIG. 2, with the packing of Example 1, even after the passage of the alkaline solution for 11 hours, neither the elution time of the peak nor the peak shape hardly changed.

Conversely, with the packing of Comparative Example 1, after the passage of the alkaline solution for 11 hours, the elution time of the peak appeared more rapidly, and the peak shape was distorted due to leading. These results further reveal that chemical modification of a silica gel surface with an alkyldisilane compound represented by General Formula [I] or [II] significantly contributes to an improvement in alkali resistance.

Measurements of the Proportions of Carbon and Coating Thicknesses

For each of the modified silica gels obtained in Examples 1 to 5, as well as Comparative Examples 1 and 2, the proportion of elemental carbon in the final product after the second step, wherein the polymer coating of an alkyldisilane compound had been formed; and that in the final product after the third step, which had been modified with an alkylmonosilane compound; were both measured. The results are shown in Table 1 below.

TABLE 1

| Examples | | |
|---|---|---|
| (Compounds Used in the | Proportion of Carbon (%) | |
| First-Step Modification) | After the Second Step | After the Third Step |
| Example 1 | 1.1 | 17.6 |
| bis(trichlorosilyl)methane | | |
| Example 2 | 1.8 | 19.0 |
| bis(trichlorosilyl)ethane | | |
| Example 3 | 2.4 | 17.5 |
| bis(trichlorosilyl)propane | | |
| Example 4 | 4.5 | 14.6 |
| bis(trichlorosilyl)hexane | | |
| Example 5 | 5.6 | 14.7 |
| bis(trichlorosilyl)octane | | |
| Comparative Example 1 | — | 16.5 |
| None | | |
| Comparative Example 2 | 0.9 | 17.2 |
| methyltrichlorosilane | | |

In Example 2, the weight ratio of the bis(trichlorosilyl)ethane used relative to the silica gel (bis(trichlorosilyl)ethane/silica gel) was 0.19. Modified silica gels wherein the weight ratio was each 0.10 or 0.38 were produced by performing up to the third step in the same manner as Example 2.

For the resulting modified silica gels, the proportion of carbon, the pore diameter, and the coating thickness of the polymer of bis(trichlorosilyl)ethane of each modified silica gel after the second step, as well as the proportion of carbon of each modified silica gel after the third step, were measured. The results are shown in Table 2 below.

TABLE 2

| Bis(trichloro- | After the Second Step | | | After the |
|---|---|---|---|---|
| silyl)ethane/ | Pore | Coating | | Third Step |
| Silica Gel | Diameter | Thickness | Proportion | Proportion |
| Weight Ratio | (Å) | (Å) | of Carbon (%) | of Carbon (%) |
| 0.10 | 98 | 1.5 | 0.9 | 16.7 |
| 0.19 | 96 | 2.5 | 1.7 | 17.8 |
| 0.38 | 95 | 3.0 | 3.0 | 17.0 |

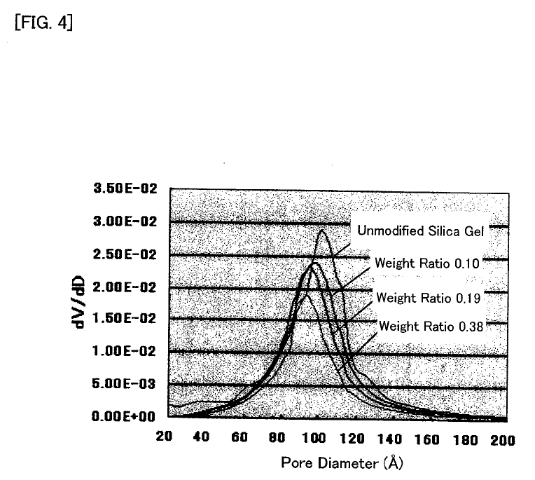

FIG. 4 shows the pore diameter distributions of an unmodified starting silica gel (Daisogel SP-120-5P) and the above-described three types of modified silica gels. It can be seen that the pore diameter distribution curves shift to smaller diameters as the bis(trichlorosilyl)ethane/silica gel weight ratio increase, revealing that a more homogeneous polymer coating was formed in the pores.

1. A modified silica gel, in which a surface of a silica gel is partially or entirely coated with a polymer or a copolymer of at least one alkyldisilane compound selected from the group consisting of:
compounds represented by General Formula [I]: 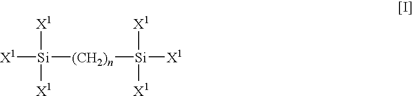
wherein each X¹ is the same or different, and is a hydrogen atom, a halogen atom, or a C₁-C₄ alkoxy group; and n is an integer from 1 to 10;
and compounds represented by General Formula [II]: 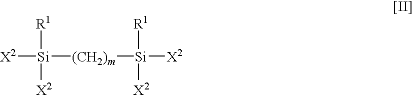
wherein each X² is the same or different, and is a hydrogen atom, a halogen atom, or a C₁-C₄ alkoxy group; each R¹ is the same or different and is a C₁-C₃₀ alkyl group; and m is an integer from 1 to 10.

2. The modified silica gel according to claim 1, wherein the polymer or copolymer and the silica gel are bonded via a siloxane bond.

3. The modified silica gel according to claim 1, wherein the weight ratio of the polymer or copolymer relative to the silica gel (the polymer or copolymer/the silica gel) is from 0.01 to 10.

4. The modified silica gel according to claim 1, wherein the polymer or copolymer coating on the silica gel is from 2 to 20 Å in thickness.

5. A modified silica gel, in which a portion of or all of silanol groups on the surface of the modified silica gel as defined in claim 1 have been modified with an alkylmonosilane compound represented by General Formula [III] below or with an alkylmonosilane compound represented by General Formula [III] wherein each R² is a C₄-C₃₀ alkyl group, and have been further modified with an alkylmonosilane compound represented by General Formula [III] wherein each R² is a C₁-C₃ alkyl group: 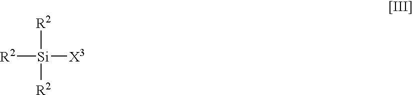
wherein X³ is a hydrogen atom, a halogen atom, or a C₁-C₄ alkoxy group; and each R² is the same or different and is a C₁-C₃₀ alkyl group.

6. A modified silica gel obtained by a process comprising:
a first step of reacting a silica gel with at least one alkyldisilane compound selected from the group consisting of:
compounds represented by General Formula [I]: 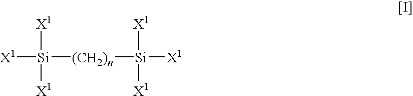
wherein each X¹ is the same or different, and is a hydrogen atom, a halogen atom, or a C₁-C₄ alkoxy group; and n is an integer from 1 to 10; and
compounds represented by General Formula [II]: 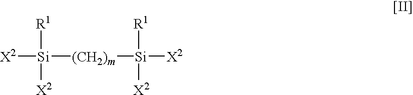
wherein each X² is the same or different, and is a hydrogen atom, a halogen atom, or a C₁-C₄ alkoxy group; each R¹ is the same or different and is a C₁-C₃₀ alkyl group; and m is an integer from 1 to 10;
to modify silanol groups of the silica gel with the alkyldisilane compound; and
a second step of reacting the reaction product obtained in the first step with water to polymerize or copolymerize the alkyldisilane compound.

7. The modified silica gel according to claim 6, wherein the weight ratio of the amount of the alkyldisilane compound used in the first step relative to the silica gel (the alkyldisilane compound/the silica gel) is from 0.01 to 10.

8. A modified silica gel obtained by a process comprising:
a first step of reacting a silica gel with at least one alkyldisilane compound selected from the group consisting of:
compounds represented by General Formula [I]: 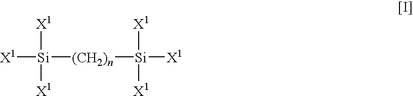
wherein each X¹ is the same or different, and is a hydrogen atom, a halogen atom, or a C₁-C₄ alkoxy group; and n is an integer from 1 to 10; and
compounds represented by General Formula [II]: 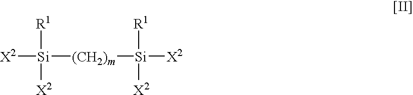
wherein each X² is the same or different, and is a hydrogen atom, a halogen atom, or a C₁-C₄ alkoxy group; each R¹ is the same or different and is a C₁-C₃₀ alkyl group; and m is an integer from 1 to 10;
to modify silanol groups of the silica gel with the alkyldisilane compound;
a second step of reacting the reaction product obtained in the first step with water to polymerize or copolymerize the alkyldisilane compound; and
a third step of reacting the reaction product obtained in the second step with an alkylmonosilane compound represented by General Formula [III] below, or with an alkylmonosilane compound represented by General Formula [III] wherein each R² is a C₄-C₃₀ alkyl group, and then further reacting the resulting reaction product with an alkylmonosilane compound represented by General Formula [III] wherein each R² is a C₁-C₃ alkyl group, to modify residual silanol groups with the alkylmonosilane compound: 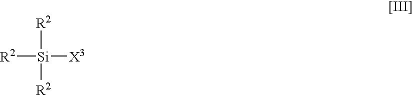
wherein X³ is a hydrogen atom, a halogen atom, or a C₁-C₄ alkoxy group; and each R² is the same or different and is a C₁-C₃₀ alkyl group.

9. The modified silica gel according to claim 8, wherein the weight ratio of the amount of the alkyldisilane compound used in the first step relative to the silica gel (the alkyldisilane compound/the silica gel) is from 0.01 to 10.

10. A process for producing a modified silica gel comprising:
a first step of reacting a silica gel with at least one alkyldisilane compound selected from the group consisting of:
compounds represented by General Formula [I]: 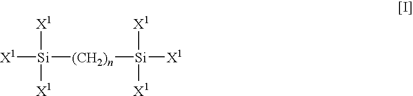
wherein each X¹ is the same or different, and is a hydrogen atom, a halogen atom, or a C₁-C₄ alkoxy group; and n is an integer from 1 to 10; and
compounds represented by General Formula [II]: 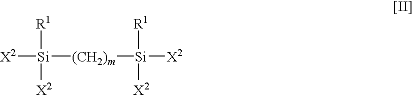
wherein each X² is the same or different, and is a hydrogen atom, a halogen atom, or a C₁-C₄ alkoxy group; each R¹ is the same or different and is a C₁-C₃₀ alkyl group; and m is an integer from 1 to 10;
to modify silanol groups of the silica gel with the alkyldisilane compound; and
a second step of reacting the reaction product obtained in the first step with water to polymerize or copolymerize the alkyldisilane compound.

11. The process according to claim 10, wherein the reaction temperature of the first step is from 60 to 200° C., and the reaction temperature of the second step is from 30 to 200° C.

12. The process according to claim 10, wherein the weight ratio of the amount of the alkyldisilane compound used in the first step relative to the silica gel (the alkyldisilane compound/the silica gel) is from 0.01 to 10.

13. The process according to claim 10, further comprising a third step of reacting the reaction product obtained in the second step with an alkylmonosilane compound represented by General Formula [III], or with an alkylmonosilane compound represented by General Formula [III] wherein each R² is a C₄-C₃₀ alkyl group, and then further reacting the resulting reaction product with an alkylmonosilane compound represented by General Formula [III] wherein each R² is a C₁-C₃ alkyl group, to modify residual silanol groups with the alkylmonosilane compound: 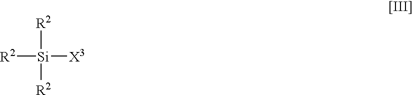
wherein X³ is a hydrogen atom, a halogen atom, or a C₁-C₄ alkoxy group; and each R² is the same or different and is a C₁-C₃₀ alkyl group.

14. A chromatographic support comprising the modified silica gel as defined in claim 1.

15. A liquid chromatographic column, which is packed with the chromatographic support as defined in claim 14.

16. A process for analyzing or fractionating a sample, using the chromatographic support as defined in claim 14.
